(19) United States
(12) Patent Application Publication
(10) Pub. No.: US 2025/0104434 A1
(43) Pub. Date: Mar. 27, 2025

(54) VIDEO-BASED PARKING SPACE OCCUPANCY DETECTION SYSTEM AND METHOD AND ARTIFICIAL INTELLIGENCE LEARNING METHOD THEREOF

(71) Applicant: VESTELLALAB INC., Seoul (KR)

(72) Inventors: Dong Su LEE, Gunpo-si (KR); Yung Ji CHOI, Seongnam-si (KR); Sangsu JUNG, Seoul (KR); Eun Jung LEE, Euiwang-si (KR)

(73) Assignee: VESTELLALAB INC., Seoul (KR)

(21) Appl. No.: 18/887,915

(22) Filed: Sep. 17, 2024

(30) Foreign Application Priority Data
Sep. 22, 2023 (KR) 10-2023-0126746

(51) Int. Cl. G06V 20/52; G06V 10/762; G06V 20/40

(52) U.S. Cl. CPC G06V 20/52; G06V 10/762; G06V 20/40; G06V 2201/08

(57) ABSTRACT

Provided is a video-based parking space occupancy detection artificial intelligence learning method. The method includes: detecting objects from a video taken of a plurality of parking spaces in a parking lot; generating learning data based on cumulative feature information that accumulates, over a certain period of time, feature information corresponding to the object detected from each image constituting the video; and learning artificial intelligence for detecting whether the object occupies the parking space based on the learning data.

### CROSS-REFERENCE TO RELATED APPLICATION

This application claims priority to and the benefit of Korean Patent Application No. 10-2023-0126746, filed on Sep. 22, 2023, the disclosure of which is incorporated herein by reference in its entirety.

### BACKGROUND

### 1. Technical Field

The present disclosure relates to video-based parking space occupancy detection system and method and an artificial intelligence learning method thereof.

### 2. Related Art

Most existing methods for finding a parking space in a parking lot were passive methods. That is, in order to find the parking space in the parking lot, a user needs to drive a vehicle through the parking lot to find the parking space with his/her eyes.

However, recently, with the development of a sensor technology, a video processing technology, and an artificial intelligence technology, a technology of automatically detecting a parking space has been developed and applied. For example, a technology is applied to detect whether a vehicle is parked by using an ultrasonic sensor or to detect whether a vehicle is parked through video analysis.

However, since a sensor-based parking detection technology needs to install a sensor in each parking space, there is a problem in that a lot of costs are required for installation and maintenance. Even when an existing video analysis technology is applied, there is a problem in that in order to recognize whether a vehicle is parked in a parking space, a person needs to directly demarcate the parking space into parking zones in advance and set all the parking zones.

Korean Patent Application Laid-Open No. 10-2020-0008807 (published on Jan. 29, 2020)

### SUMMARY

Various embodiments are directed to providing video-based parking space occupancy detection method and system that can detect whether a parking space is occupied through artificial intelligence based on feature information of objects detected and accumulated over a certain period of time even without demarcating the parking space in the parking lot into parking zones, and an artificial intelligence learning method thereof.

However, the problems to be solved by the present disclosure are not limited to the above-described problems, and other problems may be present.

In order to solve the above-described problems, a video-based parking space occupancy detection artificial intelligence learning method in accordance with a first aspect of the present disclosure includes: detecting objects from a video taken of a plurality of parking spaces in a parking lot; generating learning data based on cumulative feature information that accumulates, over a certain period of time, feature information corresponding to the object detected from each image constituting the video; and learning artificial intelligence for detecting whether the object occupies the parking space based on the learning data.

In some embodiments of the present disclosure, the generating of the learning data may include: setting a predetermined location from an object area of the detected object as feature information; and converting the feature information of each image into a numerical value, expressing the numerical value as feature information, setting a random axis for the feature information, and generating, as the cumulative feature information, statistical distribution information accumulated and densely displayed over a certain period of time on a relative coordinate system formed by the axis.

In some embodiments of the present disclosure, in the generating of the statistical distribution information as the cumulative feature information, both coordinate information at a specific location of the object area and statistical distribution information of n variables (n is a natural number) with at least one of width information, height information, object type information, and object shape information of the object area as a variable may be generated as the cumulative feature information.

In some embodiments of the present disclosure, the learning of the artificial intelligence may include: inputting feature information included in the cumulative feature information into the artificial intelligence and generating candidate cluster information by clustering the cumulative feature information according to an arbitrary standard; and re-clustering the candidate cluster information through the artificial intelligence and generating cluster information corresponding to the parking space.

In some embodiments of the present disclosure, in the generating of the candidate cluster information, when the feature information included in the cumulative feature information is concentrated more than a preset number within a certain distribution, feature information corresponding to the certain distribution may be generated as the candidate cluster information.

In some embodiments of the present disclosure, the generating of the cluster information corresponding to the parking space may include: matching a location of an actual parking space prepared in advance with at least one of the candidate cluster information; and generating at least one of the candidate cluster information matched with a location of the same parking space as the cluster information corresponding to the parking space.

A video-based parking space occupancy detection method in accordance with a second aspect of the present disclosure includes: detecting objects included in an image within a video taken of a plurality of parking spaces in a parking lot; extracting feature information corresponding to the detected objects; and inputting the feature information into an artificial intelligence learned in advance to detect whether the parking space is occupied and detecting whether the object occupies the parking space. The artificial intelligence may be learned with learning data based on cumulative feature information that accumulates, over a certain period of time, feature information corresponding to the object detected from each image constituting the video taken of the parking space.

A video-based parking space occupancy detection system in accordance with a third aspect of the present disclosure includes: a communication module configured to receive a video taken of a plurality of parking spaces in a parking lot from a camera; a memory configured to store a program for generating learning data based on the video and learning an artificial intelligence that detects whether the parking space is occupied based on the learning data; and a processor configured to execute the program stored in the memory, thereby detecting an object from the video, generating learning data based on cumulative feature information that accumulates, over a certain period of time, feature information corresponding to the object detected from each image constituting the video, and performing unsupervised learning of the artificial intelligence based on the learning data.

In addition, a computer program according to another aspect of the present disclosure is combined with a computer as hardware to execute the video-based parking space occupancy detection artificial intelligence learning method and detection method, and is stored in a computer-readable recording medium.

Other specific details of the present disclosure are included in the detailed description and drawings.

The present disclosure described above can detect whether parking spaces are occupied by many vehicles at once, that is, whether the vehicles are parked, by using only camera videos taken of a plurality of parking spaces.

In this process, unlike an existing video processing technology, there is no need to input demarcation information of a parking space into a system in advance to allow the system to recognize location information or the like of the parking space, and there is an advantage of being able to recognize a parking space and detect whether a vehicle is parked, on a probability basis through an unsupervised learning process of artificial intelligence.

In addition, by configuring various variables as learning data, there is an advantage that more accurate parking space detection and parking availability detection are possible by taking the type and shape of an object into consideration.

The effects of the present disclosure are not limited to the above-mentioned effects, and the other effects which are not mentioned herein will be clearly understood from the following descriptions by those skilled in the art.

### BRIEF DESCRIPTION OF THE DRAWINGS

FIG. 1 is a flowchart of a video-based parking space occupancy detection artificial intelligence learning method in accordance with an embodiment of the present disclosure.

FIGS. 2A and 2B are diagrams for explaining object detection results and feature information in an embodiment of the present disclosure.

FIGS. 3A, 3B, and 3C are diagrams for explaining a process of generating learning data in an embodiment of the present disclosure.

FIG. 4 is a diagram for explaining candidate cluster information in an embodiment of the present disclosure.

FIG. 5 is a diagram for explaining cluster information in an embodiment of the present disclosure.

FIG. 6 is a diagram for explaining a process of determining whether an object occupies a parking space by applying learned artificial intelligence in an embodiment of the present disclosure.

FIG. 7 is a block diagram of a video-based parking space occupancy detection system in accordance with an embodiment of the present disclosure.

### DETAILED DESCRIPTION

The advantages and characteristics of the present disclosure and a method for achieving the advantages and characteristics will be clearly understood through embodiments to be described in detail together with the accompanying drawings. However, the present disclosure is not limited to the following embodiments, but may be implemented in various forms different from each other, and the present embodiments are provided to bring the disclosure of the present disclosure to perfection and assist those skilled in the art to completely understand the scope of the present disclosure. Therefore, the present disclosure is defined only by the scope of the appended claims.

Terms used in the present specification are used for describing embodiments, not limiting the present disclosure. The terms of a singular form in the present specification may include plural forms unless specifically mentioned. The meaning of “comprise” and “comprising” used in the specification does not exclude the presence or addition of one or more other components in addition to the mentioned components. Throughout the specification, like reference numerals represent the same components, and the term “and/or” includes each of mentioned components and one or more combinations thereof. Although terms “first” and “second” are used to describe various components, the components are not limited by the terms. The terms are used only to distinguish one component from another component. Therefore, a first component described below may be a second component within the technical idea of the present disclosure.

Unless defined differently, all terms (including technical and scientific terms) used in this specification may be used as meanings which may be commonly understood by those skilled in the art to which the present disclosure pertains. Furthermore, terms which are defined in generally used dictionaries are not ideally or excessively construed unless clearly and specifically defined.

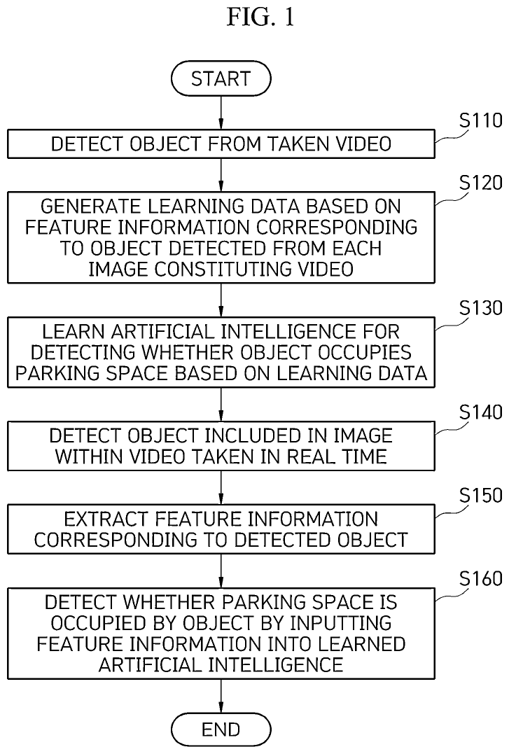

Hereinafter, video-based parking space occupancy detection artificial intelligence learning method and detection method in accordance with an embodiment of the present disclosure are described with reference to FIGS. 1 to 6.

FIG. 1 is a flowchart of a video-based parking space occupancy detection artificial intelligence learning method in accordance with an embodiment of the present disclosure. Each step illustrated in FIG. 1 may be understood as being performed by a video-based parking space occupancy detection system 100 to be described below, but is not necessarily limited thereto.

First, objects are detected from videos taken of a plurality of parking spaces in a parking lot (S110). In such a case, it is of course that a parking space in an embodiment of the present disclosure may be a video taken of a parking lot with demarcated parking surfaces, as well as a video taken of a parking lot including parking spaces with non-demarcated parking surfaces. This is possible through a process of clustering feature information in an artificial intelligence learning step to be described below.

In an embodiment, in order to detect a vehicle inside a parking lot, an object detection algorithm being one of image processing technologies may be used, which may be a deep learning-based algorithm. An embodiment of the present disclosure can automatically detect objects such as vehicles from videos through the object detection algorithm. In order to detect an object from a video, a process of identifying the location and size of the object may be performed.

Subsequently, learning data based on cumulative feature information that accumulates, over a certain period of time, feature information corresponding to the objects detected from each image constituting the video is generated (S120).

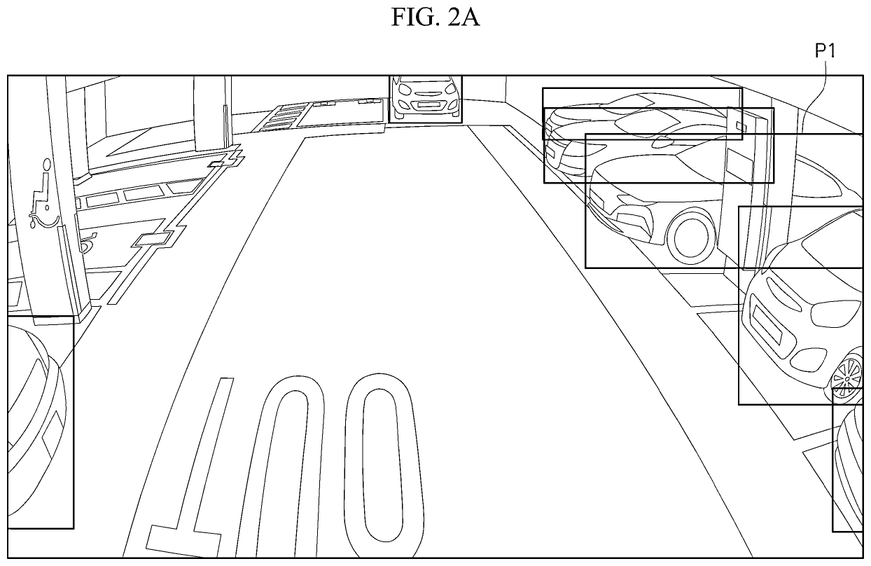

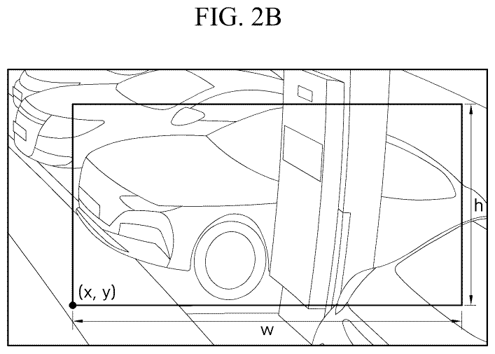

FIGS. 2A and 2B are diagrams for explaining object detection results and feature information in an embodiment of the present disclosure.

When an object is detected through an object detection algorithm, the object may be displayed together with object area information P1 as illustrated in FIG. 2A. Location information of the object detected in this way may be extracted. In such a case, in an embodiment of the present disclosure, in relation to the location information, a specific point (x, y) of an object area may be extracted as feature information as illustrated in FIG. 2B. However, the feature information is not necessarily limited thereto, and the top, bottom, left and right lengths, height values, center point coordinates, corner point coordinates, color and type information, and the like may be extracted as the feature information. Such feature information may be one obtained by extracting only one specified coordinate value. Alternatively, the feature information may be one obtained by extracting a plurality of coordinate values, or one obtained by combining and extracting a plurality of feature information having different locations and characteristic information.

In an embodiment of the present disclosure, different feature information may be extracted for each location of a parking space constituting a parking lot. This is because the location and shape of an object area detected vary depending on the location of the parking space in an image, especially, the direction. Accordingly, as an example, based on an image of a camera in FIG. 2A, the coordinates of a lower left point of object area information may be extracted as feature information in the case of parking spaces on the right, the coordinates of a lower center point may be extracted as feature information in the case of front parking spaces, and the coordinates of a lower right point may be extracted as feature information in the case of parking spaces on the left.

The extracted feature information may be used as information representing the detected object, and after learning is completed, the feature information may be used for parking management such as detecting whether a vehicle occupies the parking space and determining the parking status of the vehicle. As described above, the parking space may be a space where a vehicle is customarily parked in a space with non-demarcated parking spaces.

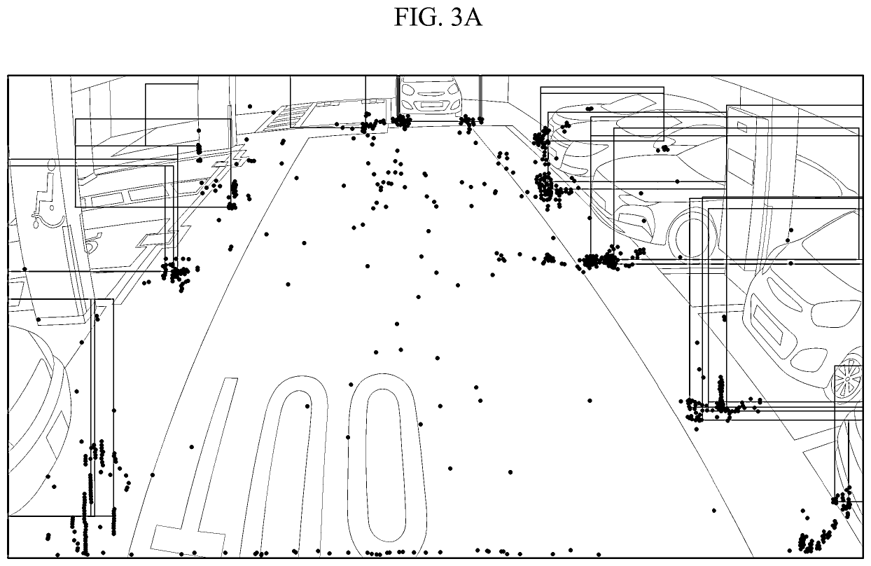

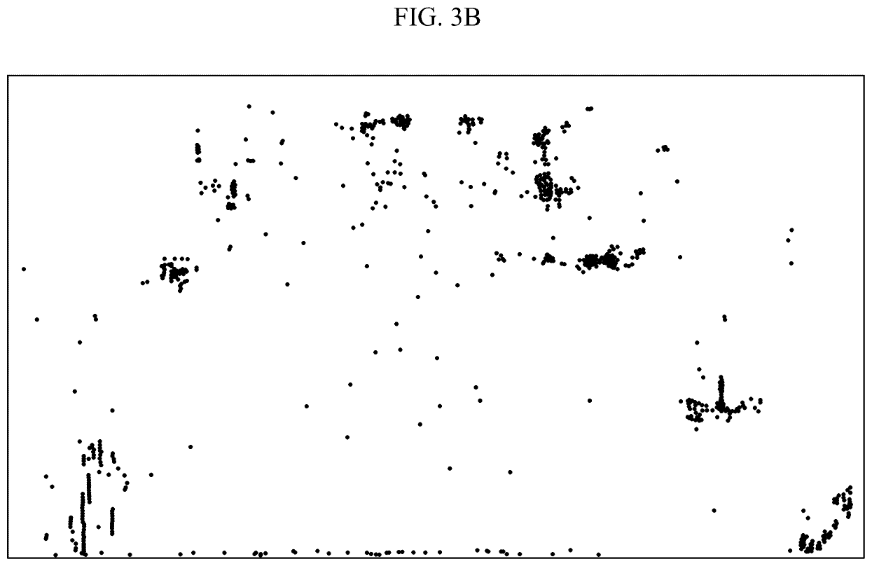

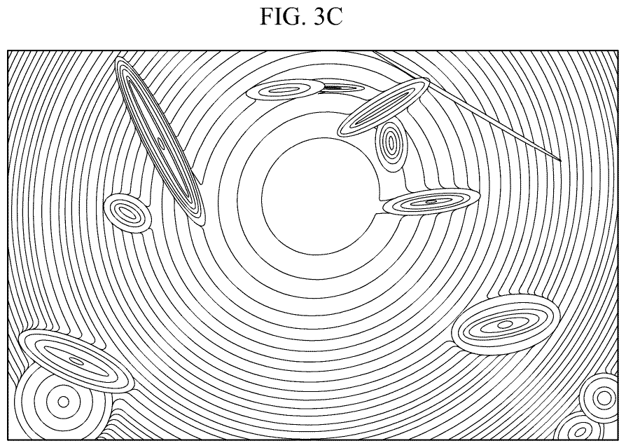

FIGS. 3A and 3B are diagrams for explaining a process of generating learning data in an embodiment of the present disclosure.

After the feature information is extracted from the object area of the detected object, a random axis is set for the feature information of each image, and statistical distribution information (for example, histogram information) accumulated and displayed over a certain period of time on a relative coordinate system formed by the axis may be generated as cumulative feature information.

In such a case, in an embodiment of the present disclosure, not only coordinate information at a specific location of the object area, but also statistical distribution information of n variables (n is a natural number) with at least one of width information, height information, object type information, and object information of the object area as a variable may be used as the cumulative feature information.

For example, two-variable statistical distribution information to which coordinate information (x, y) of a specific reference point is applied may be configured as learning data. As another example, one-variable statistical distribution information to which only information (for example, x-axis) collected based on one of the axes is applied may be configured as learning data. In addition, n-variable statistical distribution information may also be configured by combining the height (h), width (w), or diagonal length (d) of the object area.

Moreover, an embodiment of the present disclosure may also configure statistical distribution information of n variables by further combining object type information and object shape information. In such a case, considering the object type information and the object shape information as variables is for more accurately recognizing and detecting parked vehicles because various models and types of vehicles exist in a parking lot video.

Specifically, in an embodiment of the present disclosure, when the object type information is considered as a variable, various models in the parking lot may be more accurately distinguished. For example, since different variable values may be applied to models such as general passenger cars, SUVs, and trucks and respective models have different characteristics such as parking locations and sizes, considering the type of object as a variable has the advantage of enabling more accurate parking space detection and detection of whether the object is occupied.

In an embodiment of the present disclosure, when the object shape information is considered as a variable, different variables are applied depending on the shapes of parked vehicles, thereby enabling more accurate parking space detection and detection of whether the object is occupied. That is, since the parking direction and location are different depending on the shapes of parked vehicles, different variables are applied to long-passenger cars (mid-to large-sized sedans or the like) and short-passenger cars (compact cars or the like), thereby enabling more accurate parking space detection and detection of whether the object is occupied.

In this way, an embodiment of the present disclosure further considers the object type information and the object shape information, thereby additionally distinguishing various models and types of vehicles in a parking lot and more accurately detecting whether parking spaces are occupied by various vehicles. In such a case, different candidate cluster information may be generated by distinguishing vehicles according to the type and shape of the object, but finally, one cluster information is generated for one parking space, and various information can be provided by generating different candidate cluster information.

On the other hand, an embodiment of the present disclosure can perform a data preprocessing process before generating statistical distribution information for feature information collected over a certain period of time. In such a case, an embodiment of the present disclosure can generate statistical distribution information after performing preprocessing such as noise removal and pruning on the feature information.

An embodiment of the present disclosure can further diagram the distribution of feature information when generating statistical distribution information.

In an embodiment, the statistical distribution information may further provide the density of the distribution of feature information, and the density may be provided in a diagrammatic manner. As an example, the density may be displayed in different colors for each grade. As another example, the density may be displayed in the form of a contour line as illustrated in FIG. 3C. In this way, the statistical distribution information may provide density information, which may be generated as cluster information in a process of learning artificial intelligence.

Subsequently, artificial intelligence for detecting whether the object occupies the parking space is learned based on the learning data (S130).

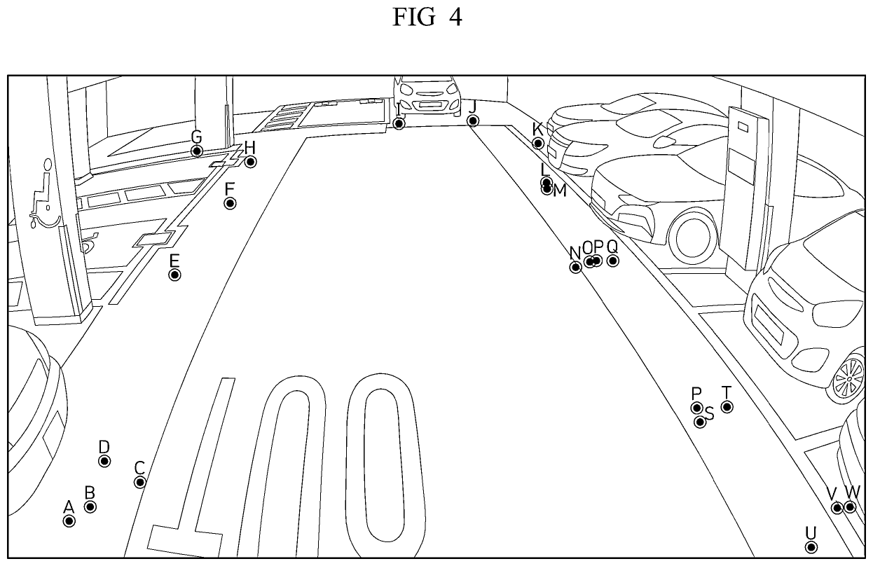

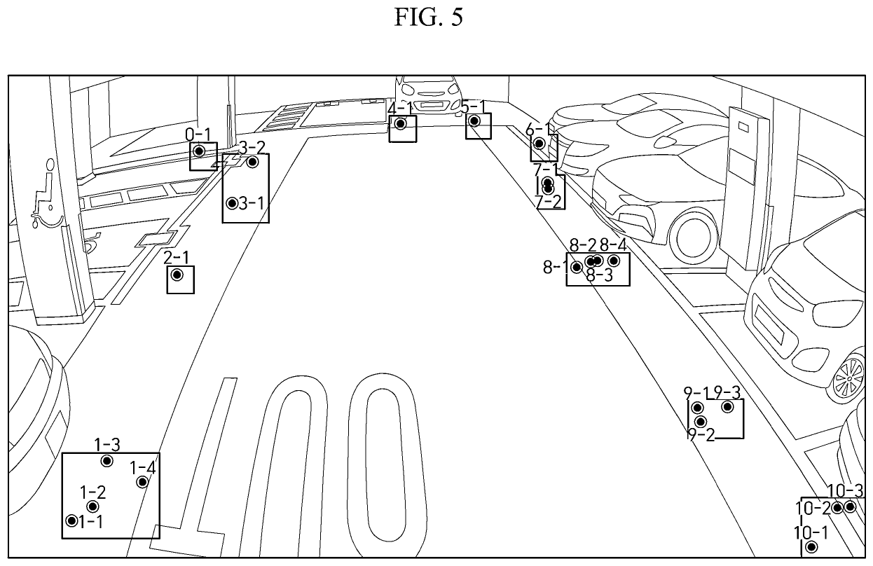

FIG. 4 is a diagram for explaining candidate cluster information in an embodiment of the present disclosure. FIG. 5 is a diagram for explaining cluster information in an embodiment of the present disclosure.

An embodiment of the present disclosure can perform unsupervised learning of artificial intelligence through cumulative feature information based on statistical distribution information in the previous step.

In such a case, in order to enable artificial intelligence to perform unsupervised learning, that is, to train itself, the present disclosure may first input feature information included in the cumulative feature information into the artificial intelligence, and generate candidate cluster information that the artificial intelligence clusters +itself according to an arbitrary standard. In FIG. 4, the candidate cluster information is indicated by A to W.

The arbitrary standard may be a standard that the artificial intelligence finds or sets by itself. In an embodiment, when the feature information included in the cumulative feature information is concentrated more than a preset number within a certain distribution or when conditions such as a certain standard deviation, Z, and confidence interval are satisfied in a population distribution estimated through the distribution, the artificial intelligence may generate feature information corresponding to the certain distribution as the candidate cluster information. In another embodiment, the artificial intelligence may calculate the similarity between the feature information included in the cumulative feature information, cluster feature information with similarity equal to or greater than a preset threshold, and generate the clustered information as the candidate cluster information. That is, in an embodiment of the present disclosure, the artificial intelligence may generate the candidate cluster information by performing automatic pattern recognition and statistical classification on data through unsupervised learning. In such a case, it is of course that the standard used may be set in various ways depending on the characteristics of the algorithm and the characteristics of the data.

After the candidate cluster information is generated, an embodiment of the present disclosure can re-cluster the candidate cluster information through the artificial intelligence and generate the re-clustered information as cluster information corresponding to the parking space. FIG. 5 illustrates an example in which a total of 10 pieces of cluster information is generated. In such a case, candidate cluster information A to D are generated as cluster information No. 1 (1-1 to 1-4) and candidate cluster information E is generated as cluster information No. 2 (2-1).

In the artificial intelligence learning process of generating the cluster information through the candidate cluster information, the location of an actual parking space prepared in advance may be first matched with at least one candidate cluster information, and at least one candidate cluster information matched or tagged with the location of the same parking space may be generated as the cluster information corresponding to the parking space.

The location of the actual parking space in a parking lot may be acquired from a video or a prepared parking lot map and matched with candidate cluster information. Such a matching process may detect and match common features or similar patterns between the actual parking space and the candidate cluster information.

In the case of a parking lot with non-demarcated parking spaces other than a general parking lot with demarcated parking spaces, information on an actual parking space may be set in advance, or may be set by being collected and analyzed based on parking patterns of existing vehicles. Alternatively, the artificial intelligence may perform matching through a comparison process with characteristics of the surrounding environment (for example, buildings, trees, roads, other structures, and the like).

On the other hand, in the case where there is no parking surface demarcation, various types of cluster information is preferably generated by applying information such as multivariate histograms and scatterplots when the above-described statistical distribution information is applied. For example, by setting object type information, object shape information, and the like as variables of statistical distribution information, artificial intelligence may be learned to match parking spaces for enabling parking of various sizes and types of vehicles with candidate cluster information.

In addition, it is of course that when the number of candidate cluster information is not large, a matching process between candidate cluster information and actual parking spaces may also be manually performed by a manager.

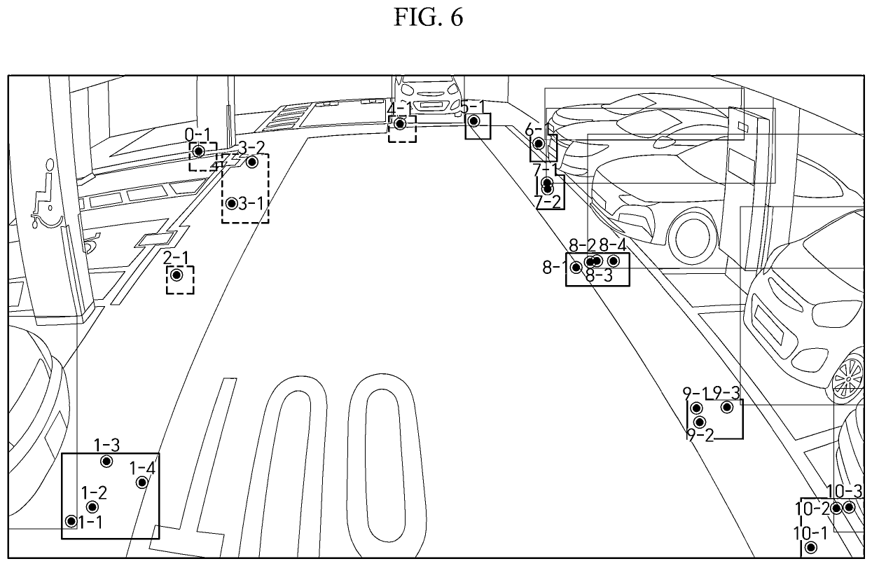

FIG. 6 is a diagram for explaining a process of determining whether an object occupies a parking space by applying learned artificial intelligence in an embodiment of the present disclosure.

After the learning of the artificial intelligence is completed, objects included in images in the video taken of the plurality of parking spaces in the parking lot are detected in real time (S140), and feature information of the detected objects is extracted (S150).

Subsequently, by inputting the feature information into the learned artificial intelligence, the result of detecting whether the parking space is occupied by the object may be output (S160).

On the other hand, in learning the artificial intelligence, in the case of underground parking lots, there may be many cases where vehicles temporarily park in front of an entrance for people to enter a building, even though it is not a parking space. In such a case, when feature information is configured as cumulative feature information as is, an error may occur in generating cluster information corresponding to a parking space even though it is a non-parking space.

In order to solve such a problem, an embodiment of the present disclosure can configure learning data by further adding vehicle parking time information when configuring variables constituting statistical distribution information. Subsequently, an average parking time of vehicles corresponding to feature information within a cluster is calculated based on generated cluster information, and when the average parking time satisfies preset minimum parking time information or more, the cluster information may be determined as a parking space. In such a case, the minimum parking time information may be set to a lower specific % or more or a minimum value of parking time statistics in the parking space of the vehicles determined to be parking spaces, and the time corresponds to the time from when parking is completed until the same vehicle leaves the parking lot again.

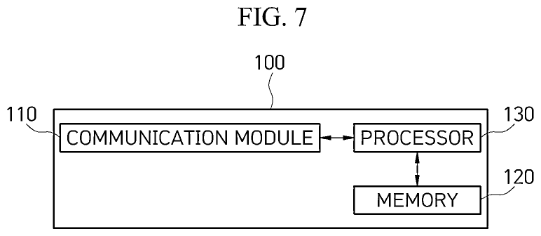

In the above description, steps S110, S120, S130, S140, S150, and S160 may be further divided into additional steps or combined into fewer steps, depending on the implementation of the present disclosure. Some steps may also be omitted as needed or the order between the steps may also be changed. In addition, even in the case of other omitted content, the content of FIGS. 1 to 6 may also be applied to the content of the video-based parking space occupancy detection system 100 in FIG. 7 to be described below.

FIG. 7 is a block diagram of the video-based parking space occupancy detection system 100 in accordance with an embodiment of the present disclosure.

The video-based parking space occupancy detection system 100 in accordance with an embodiment of the present disclosure includes a communication module 110, a memory 120, and a processor 130.

The communication module 110 receives a video taken of a plurality of parking spaces in a parking lot from a camera. Such a communication module 110 may include both a wired communication module and a wireless communication module. The wired communication module may be implemented with a power line communication device, a telephone line communication device, a home cable MoCA, the Ethernet, an IEEE1294, an integrated wired home network, and an RS-485 control device. The wireless communication module may be implemented with a wireless LAN (WLAN), a Bluetooth, a HDR WPAN, a UWB, a ZigBee, an impulse radio, a 60 GHz WPAN, a binary-CDMA, a wireless USB technology, a wireless HDMI technology, or the like.

The memory 120 stores a program for generating learning data based on the video and learning an artificial intelligence that detects whether the parking space is occupied based on the learning data, and the processor 130 executes the program stored in the memory 120.

The memory 120 is a general term for volatile storage devices and nonvolatile storage devices that continuously retain stored information even though no power is supplied. For example, the memory 120 may include a NAND flash memory such as a compact flash (CF) card, a secure digital (SD) card, a memory stick, a solid-state drive (SSD), and a micro SD card, a magnetic computer storage device such as a hard disk drive (HDD), and an optical disc drive such as a CD-ROM and a DVD-ROM.

The processor 130 detects an object from the video, generates learning data based on cumulative feature information that accumulates, over a certain period of time, feature information corresponding to the object detected from each image constituting the video, and performs unsupervised learning of artificial intelligence based on the learning data.

The video-based parking space occupancy detection artificial intelligence learning method and detection method in accordance with the embodiment of the present disclosure described above may be implemented with a program (or application) and stored in a medium, so as to be executed through a computer as hardware which is coupled thereto.

The above-described program may include codes written by a computer language such as C, C++, JAVA, Ruby, Swift, JavaScript, Python, or machine language, which can be read by a processor (CPU) of the computer through a device interface of the computer, in order to execute the above-described methods which are implemented as a program read by the computer. Such codes may include a functional code related to a function defining functions required for executing the above-described methods, and include an execution procedure-related control code required for the processor of the computer to execute the functions according to a predetermined procedure. Furthermore, such codes may further include additional information required for the processor of the computer to execute the functions or a memory reference-related code indicating the position (address) of an internal or external memory of the computer, where a medium needs to be referred to. Furthermore, when the processor of the computer needs to communicate with another remote computer or server in order to execute the functions, the codes may further include communication-related codes indicating how to communicate with another remote computer or server by using a communication module of the computer and which information or media to transmit or receive during communication.

The stored medium does not indicate a medium such as a register, cache or memory, which stores data for a short moment, but indicates a medium which semi-permanently stores data and can be read by a device. Specifically, examples of the storage medium include a ROM, RAM, CD-ROM, magnetic tape, floppy disk, optical data storage device and the like, but are not limited thereto. That is, the program may be stored in various recording media on various servers which the computer can access or various recording media of a user's computer. Furthermore, the media may store codes which can be distributed in computer systems connected through a network, and read by computers in a distributed manner.

The descriptions of the present disclosure are only examples, and those skilled in the art to which the present disclosure pertains will understand that the present disclosure can be easily modified into other specific forms without changing the technical spirit or essential features of the present disclosure. Therefore, it should be understood that the above-described embodiments are only illustrative in all aspects and are not limitative. For example, components described in a singular form may be distributed and embodied. Similarly, distributed components may be embodied in a coupled form.

The scope of the present disclosure is defined by the claims to be described below rather than the detailed description, and it should be construed that the meaning and scope of the claims and all changes or modified forms derived from the equivalent concept thereof are included in the scope of the present disclosure.

What is claimed is:

1. A video-based parking space occupancy detection artificial intelligence learning method performed by a computer, comprising:
detecting objects from a video taken of a plurality of parking spaces in a parking lot;
generating learning data based on cumulative feature information that accumulates, over a certain period of time, feature information corresponding to the object detected from each image constituting the video; and
learning artificial intelligence for detecting whether the object occupies the parking space based on the learning data.

2. The video-based parking space occupancy detection artificial intelligence learning method of claim 1, wherein the generating of the learning data comprises:
setting predetermined location coordinates and characteristics from an object area of the detected object as feature information; and
setting a random axis for the feature information of each image, and generating, as the cumulative feature information, statistical distribution information accumulated and densely displayed over a certain period of time on a relative coordinate system formed by the axis.

3. The video-based parking space occupancy detection artificial intelligence learning method of claim 2, wherein, in the generating of the statistical distribution information as the cumulative feature information, both coordinate information at a specific location of the object area and statistical distribution information of n variables (n is a natural number) with at least one of width information, height information, object type information, and object shape information of the object area as a variable are generated as the cumulative feature information.

4. The video-based parking space occupancy detection artificial intelligence learning method of claim 1, wherein the learning of the artificial intelligence comprises:
inputting feature information included in the cumulative feature information into the artificial intelligence and generating candidate cluster information by clustering the cumulative feature information according to an arbitrary standard; and
re-clustering the candidate cluster information through the artificial intelligence and generating cluster information corresponding to the parking space.

5. The video-based parking space occupancy detection artificial intelligence learning method of claim 4, wherein, in the generating of the candidate cluster information, when the feature information included in the cumulative feature information is concentrated more than a preset number within a certain distribution or are more than a preset statistical value, feature information corresponding to the certain distribution is generated as the candidate cluster information.

6. The video-based parking space occupancy detection artificial intelligence learning method of claim 4, wherein the generating of the cluster information corresponding to the parking space comprises:
matching a location of an actual parking space prepared in advance with at least one of the candidate cluster information; and
generating at least one of the candidate cluster information matched with a location of a same parking space as the cluster information corresponding to the parking space.

7. A video-based parking space occupancy detection method performed by a computer, comprising:
detecting objects included in an image within a video taken of a plurality of parking spaces in a parking lot;
extracting feature information corresponding to the detected objects; and
inputting the feature information into an artificial intelligence learned in advance to detect whether the parking space is occupied and detecting whether the object occupies the parking space,
wherein the artificial intelligence is learned with learning data based on cumulative feature information that accumulates, over a certain period of time, feature information corresponding to the object detected from each image constituting the video taken of the parking space.

8. A video-based parking space occupancy detection system, comprising:
a communication module configured to receive a video taken of a plurality of parking spaces in a parking lot from a camera;
a memory configured to store a program for generating learning data based on the video and learning an artificial intelligence that detects whether the parking space is occupied based on the learning data; and
a processor configured to execute the program stored in the memory, thereby detecting an object from the video, generating learning data based on cumulative feature information that accumulates, over a certain period of time, feature information corresponding to the object detected from each image constituting the video, and performing unsupervised learning of the artificial intelligence based on the learning data.
